(19) United States
(12) Patent Application Publication
(10) Pub. No.: US 2010/0194866 A1
(43) Pub. Date: Aug. 5, 2010

(54) Electronic imaging device and driving method thereof

(76) Inventor: Naoaki Komiya, Yongin-City (KR)

Correspondence Address: LEE & MORSE, P.C., 3141 FAIRVIEW PARK DRIVE, SUITE 500, FALLS CHURCH, VA, 22042, US

(21) Appl. No.: 12/656,050

(22) Filed: Jan. 14, 2010

(30) Foreign Application Priority Data
Feb. 5, 2009 (KR) 10-2009-0009363

(51) Int. Cl. H04N 13/04; G02B 27/22; G09G 5/00

(52) U.S. Cl. 348/54; 359/464; 345/214; 348/E13.075

(57) ABSTRACT

An electronic imaging device includes a display unit including a plurality of pixels divided into a first region and a second region, and a controller that generates first and second control signals to control the light emission of the plurality of pixels and applies the first and second control signals to the plurality of pixels in the first region and the plurality of pixels in the second region, respectively. The controller may generate and apply the first control signal as a turn-off signal when second stereoscopic images synthesized in a second order different from a first order are displayed in the first region after first stereoscopic images synthesized in the first order are displayed in both the first and second regions.

### BACKGROUND OF THE INVENTION

1. Field

Embodiments relate to an electronic imaging device. More particularly, embodiments relate to an electronic imaging device and a driving method thereof that is capable of displaying stereoscopic images and plane images.

2. Description of the Related Art

Generally, physiological factors and empirical factors allow a person to perceive a stereoscopic effect. In the three-dimensional image displaying technology, a stereoscopic effect of an object is generally represented by using binocular parallax, which is the most critical factor to allow a person to perceive the stereoscopic effect at a close range. The electronic imaging device displaying the stereoscopic images uses a method that spatially separates left and right images using optical devices. Representative methods include using a lenticular lens array and using a parallax barrier.

However, when displaying the stereoscopic image, since the stereoscopic image is separated into an image projected on a left eye (hereinafter referred to as “left-eye image”) and an image projected on a right eye (hereinafter referred to as “right-eye image”), resolution of the stereoscopic image is halved compared with that of a plane image.

The above information disclosed in this Background section is only for enhancement of understanding of the background of the invention and therefore it may contain information that does not form the prior art that is already known in this country to a person of ordinary skill in the art.

### SUMMARY

Embodiments are therefore directed to an electronic imaging device and a driving method thereof, which substantially overcome one or more of the problems due to the limitations and disadvantages of the related art.

It is therefore a feature of an embodiment to provide an electronic imaging device and a driving method thereof capable of sharply displaying stereoscopic images.

It is another feature of an embodiment to provide an electronic imaging device and a driving method thereof capable of preserving resolution during display of stereoscopic images.

At least one of the above and other features and advantages may be realized by providing an electronic imaging device including a display unit including a plurality of pixels divided into a first region and a second region, and a controller that generates first and second control signals to control the light emission of the plurality of pixels and applies the first and second control signals to the plurality of pixels in the first region and the plurality of pixels in the second region, respectively. The controller may generate and apply the first control signal as a turn-off signal when second stereoscopic images synthesized in a second order different from a first order are displayed in the first region after first stereoscopic images synthesized in the first order are displayed in both the first and second regions.

The controller may generate and supply the second control signal as a turn-off signal, and generate and supply the first control signal as a turn-on signal, when the second stereoscopic images are displayed in the second region after the second stereoscopic images are displayed throughout the first region.

The electronic imaging device may include a barrier unit including a first sub-barrier that displays the first stereoscopic images and a second sub-barrier that displays the second stereoscopic images.

When the first stereoscopic images are displayed on the first and second regions, the first sub-barrier may become non-transmitting and the second sub-barrier may become transmitting. When the second stereoscopic images are displayed in the first and second regions, the second sub-barrier may become non-transmitting and the first sub-barrier may become transmitting.

Each of the plurality of pixels may include a driving transistor including a first terminal and a second terminal, the first terminal configured to receive any one of the first and second control signals, the second terminal configured to receive data signals, the driving transistor configured to output a difference signal corresponding to a difference between a signal level at the first terminal and the second terminal, and an organic light emitting device connected to the driving transistor and configured to emit light in accordance with the difference signal.

The first order may be an order of left-eye images and right-eye images and the second order may be an order of right-eye images and left-eye images.

The first and second control signals may be drive voltages or may be light emission control signals.

The controller may generate and apply the second light emission control signal as a turn-off voltage at a point in time when the second stereoscopic images are displayed in the second region after the second stereoscopic images are displayed throughout the first region.

Each of the plurality of pixels may include a switching device that is turned on by the scan signal and transfers the data signals, a driving transistor that is driven according to the output of the switching device and generates a current, an organic light emitting device that is light-emitted by the current, and a light emission control transistor that is connected between the driving transistor and the organic light emitting device and is turned on by any one of the first and second light emission control signals to supply the current to the organic light emitting device.

At least one of the above and other features and advantages may also be realized by providing a method of driving an electronic imaging device including a display unit having a plurality of pixels, the method including displaying first stereoscopic images synthesized in a first order throughout a first region where a plurality of first pixels of the plurality of pixels of the display unit are located and a second region where another plurality of second pixels of the plurality of pixels of the display unit are located, and turning off the plurality of first pixels when the second stereoscopic images synthesized in a second order different from the first order starts to display in the first region.

Turning off the plurality of first pixels may include using a driving voltage applied to the driving transistor as a turn-off voltage.

The method may include turning off the plurality of second pixels when the second stereoscopic images are displayed in the second region and turning on the plurality of first pixels when the second stereoscopic images are displayed throughout the first region.

The method may include making the first sub-barrier non-transmitting and the second sub-barrier transmitting, for a period where the first stereoscopic images are displayed on the entire display unit and where the second stereoscopic images are displayed throughout the first region, and making the second sub-barrier non-transmitting and the first sub-barrier transmitting, from a point in time when the second stereoscopic images are displayed in the second region.

The first order may be an order of left-eye images and right-eye images and the second order may be an order of right-eye images and left-eye images.

Turning off the plurality of first pixels may include turning off light emission control transistors associated with corresponding first pixels.

The method may include turning on the light emission control transistors associated with the plurality of first pixels when second stereoscopic images start to display in the second region.

Displaying may include emitting light from an organic light emitting device.

Emitting light may include supplying a current from a driving transistor connected to the organic light emitting device.

Supplying the current may include turning on a light emission control transistor connected between the driving transistor and the organic light emitting device.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of an electronic imaging device according to a first exemplary embodiment;

FIG. 2 illustrates an equivalent circuit diagram of a pixel shown in FIG. 1;

FIGS. 3A and 3B illustrate diagrams of a time division scheme according to an exemplary embodiment;

FIG. 4 illustrates a diagram of a barrier according to an exemplary embodiment;

FIGS. 5A to 5D illustrate diagrams of a display unit while the electronic imaging device according to the first exemplary embodiment is changed from left and right images LR to right and left images RL;

FIG. 6 illustrates a diagram of first and second driving voltages ELV1 and ELV2;

FIG. 7 illustrates a diagram of first and second barrier driving signals CB1 and CB2;

FIG. 8 illustrates a block diagram of an electronic imaging device according to a second exemplary embodiment;

FIG. 9 illustrates an equivalent circuit diagram of a pixel shown in FIG. 8;

FIG. 10 illustrates a diagram of first and second light emission control signals EM1 and EM2; and

FIG. 11 illustrates a diagram of first and second barrier driving signals CB1 and CB2.

### DETAILED DESCRIPTION

Korean Patent Application No. 10-2009-0009363 filed on Feb. 5, 2009, in the Korean Intellectual Property Office, and entitled: “Electronic Imaging Device and the Method Thereof,” is incorporated by reference herein in its entirety.

In the following detailed description, only certain exemplary embodiments have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

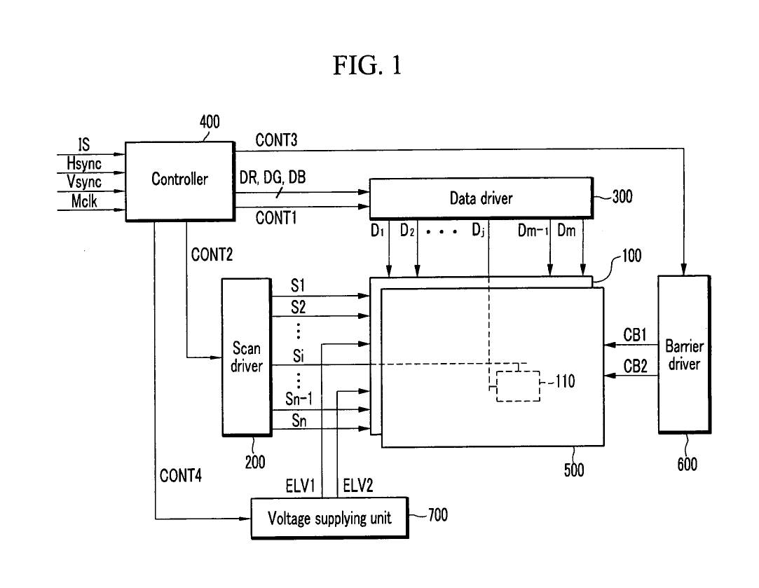

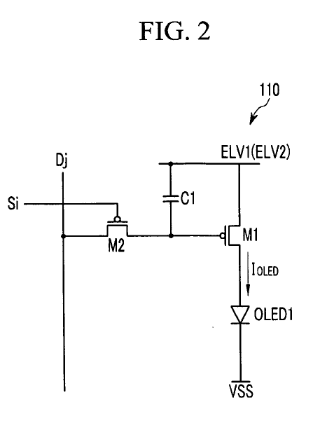

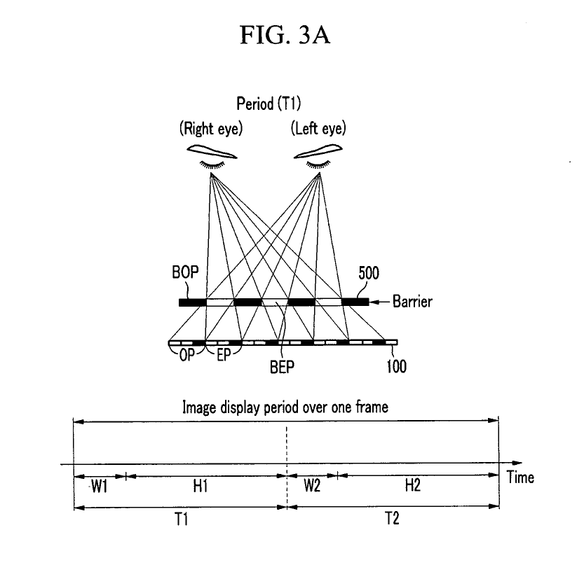

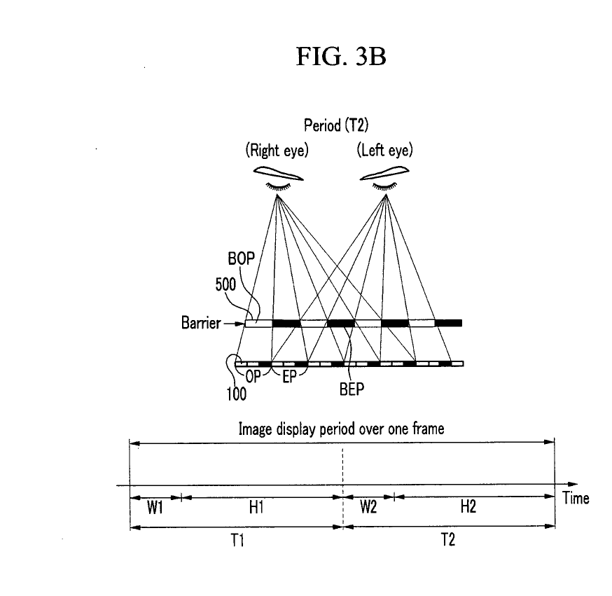

FIG. 1 illustrates a block diagram of an electronic imaging device according to a first exemplary embodiment. FIG. 2 illustrates an equivalent circuit diagram of a pixel 110 shown in FIG. 1. FIGS. 3A and 3B illustrate a time-division scheme according to an exemplary embodiment. FIG. 4 illustrates a diagram of a barrier according to an exemplary embodiment.

Referring to FIG. 1, an electronic imaging device according to the first exemplary embodiment may include a display unit 100, a scan driver 200, a data driver 300, a controller 400, a barrier unit 500, a barrier driver 600, and a voltage supplying unit 700.

The display unit 100 may include a plurality of signal lines S1 to Sn and D1 to Dm, a plurality of voltage lines (not shown), and a plurality of pixels 110 that are connected thereto and substantially arranged in a matrix form, when viewed from an equivalent circuit perspective.

The signal lines S1 to Sn and D1 to Dm may include a plurality of scan lines S1 to Sn that transfer scan signals and a plurality of data lines D1 to Dm that transfer data signals. The plurality of scan lines S1 to Sn may approximately extend in a row direction and may be approximately parallel with each other. The plurality of data lines D1 to Dm may approximately extend in a column direction and may be approximately parallel with each other.

The data signal may be a voltage signal (hereinafter referred to as a “data voltage”) or a current signal (hereinafter referred to as a “data current”) according to the type of pixel 110. Hereinafter, the data signal will be described as a data voltage.

The scan driver 200 may be connected to the scan lines S1 to Sn of the display unit 100 and may sequentially apply the scan signals to the scan lines S1 to Sn. Herein, the scan signal is a signal that turns on/off a switching transistor M2 (see FIG. 2) of the pixel 110.

The data driver 300 may be connected to the data lines D1 to Dm of the display unit 100, may convert input image data DR, DG, and DB input from the controller 400 into data voltages, and may apply the data voltages to the data lines D1 to Dm.

Referring to FIG. 2, each pixel 110, e.g., a pixel 110 connected to an i-th scan line Si (i=1, 2, . . . , n) and a j-th data line Dj (j=1, 2, . . . , m), may include an organic light emitting device OLED1, a driving transistor M1, a capacitor C1, and the switching transistor M2.

The organic light emitting device OLED1 may be an organic light emitting diode (OLED), and may include an anode connected to an output terminal of the driving transistor M1 and a cathode connected to a common voltage Vss. The organic light emitting device OLED1 displays images by emitting light at different intensities according to an output current I_{OLED} of the driving transistor M1.

The organic light emitting device OLED1 may emit light of one of at least two primary colors. For example, the primary colors may include three primary colors, e.g., red, green, and blue, and a desired color may be displayed by a spatial sum or a temporal sum of these three primary colors.

Alternatively or additionally, some organic light emitting device OLED1 may emit white light, thereby increasing luminance. When the organic light emitting device OLED1 of all the pixels 110 emits white light, some pixels 110 may further include a color filter (not shown) that converts white light from the organic light emitting device OLED1 into any one of the primary colors.

The driving transistor M1 may include a control terminal, an input terminal, and an output terminal. The control terminal may be connected to the switching transistor M2, the input terminal may be connected to an output of the power supplying unit 700, and the output terminal may be connected to the organic light emitting device OLED1. The driving transistor M1 may transfer the current I_{OLED} whose magnitude varies according to a voltage applied between the control terminal and the output terminal.

The capacitor C1 may be connected between the control terminal and the input terminal of the driving transistor M1. The capacitor C1 may charge a data voltage applied to the control terminal of the driving transistor M1 and may maintain this data voltage even after the switching transistor M2 is turned off.

The switching transistor M2 may include a control terminal, an input terminal, and an output terminal. The control terminal may be connected to the scan line Si, the input terminal may be connected to the data line Dj, and the output terminal may be connected to the driving transistor M1. The switching transistor M2 may transfer the data signal applied to the data line Dj, i.e. the data voltage, in response to the scan signal applied to the scan line Si.

The switching transistor M2 and the driving transistor M1 may be p-channel field effect transistors (FETs). In this case, the control terminal, the input terminal, and the output terminal each respectively corresponds to a gate, a source, and a drain. However, either one or both of the switching transistor M2 and the driving transistor M1 may be a different type of transistor, e.g., an n-channel FET.

Further, a connection relationship of the driving transistor M1, the switching transistor M2, the capacitor C1, and the organic light emitting device OLED1 may be changed.

Referring back to FIG. 1, the controller 400 may receive an input signal IS, a horizontal synchronization signal Hsync, a vertical synchronization signal Vsync, and a main clock signal MCLK from the outside, may generate a scan control signal CONT1, a data control signal CONT2, image data signals DR, DG, and DB, a barrier driver control signal CONT3, and a voltage supplying control signal CONT4, and may transfer these signals to the scan driver 200, the data driver 300, the barrier driver 500, and the voltage supplying unit 700, respectively.

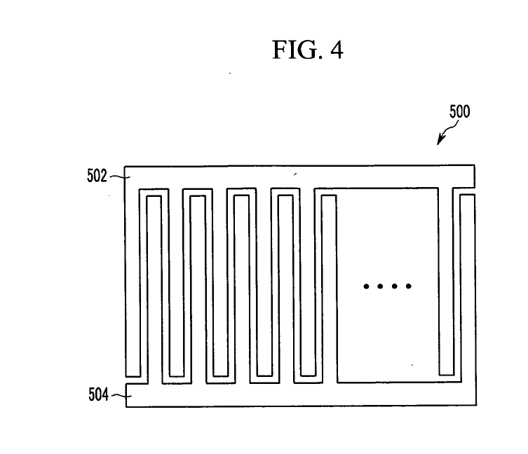

Herein, the voltage supplying control signal CONT4 according to the first exemplary embodiment is a signal that controls the voltage levels of the first driving voltage ELV1 and the second driving voltage ELV2 that are supplied to the first and second regions 102 and 104 (described in detail below with reference to FIGS. 5A to 5D) of the display unit 100, respectively.

In detail, the first and second driving voltages ELV1 and ELV2 each has a turn-on voltage VON that turns on the pixel 110 and a turn-off voltage VOFF that turns off the pixel 110. The turn-on voltage VON may be a sufficiently high voltage VDD that can operate the driving transistor M1 in a saturation region throughout the range of the voltage of the data signal Dj applied to the gate electrode of the driving transistor M1. The turn-off voltage VOFF may be in a voltage range that does not transfer a current to the driving transistor M1.

The first region 102 and the second region 104 may be divided based on the pixel 110 of one row corresponding to the i-th scan line Si of the scan lines S1 to Sn. The i-th scan line Si may be defined by a line that is connected with the pixel 110 positioned at the center of the display unit 100.

The barrier unit 500 may be operated according to the time-division driving scheme when the stereoscopic image is displayed. The barrier unit 500 may include first and second barriers 502 and 504 (see FIG. 4) driven by first and second barrier driving signals CB1 and CB2. The barrier unit 500 may be in a transmitting state to transmit the images on the display unit 100 as is when plane images are displayed.

The time-division driving scheme may include: 1) a scheme that alternately operates a light source left and right and divides the left and right by time division using an optical device, e.g., a combination of a prism and a lenticular lens; and 2) a scheme that moves a slit transmitting light in a liquid crystal barrier in synchronization with the displayed image by dividing one existing section into several sections.

The electronic imaging device according the exemplary embodiment will be described with reference to a case when it is driven by the method 2). However, embodiments are not limited thereto, and may use an optical device, e.g., a combination of a light source, a prism, and a lenticular lens, instead of a liquid crystal barrier, when the method 1) is used.

Further, FIGS. 3A and 3B basically describe a case of two eyes, but embodiments are not limited thereto, and the same principle is applicable even in a case of multiple eyes. First, FIG. 3A illustrates when images (hereinafter referred to as left and right images) synthesized in an order of left-eye images and right-eye images for a first period T1 are displayed to a user when one frame is divided into two periods, e.g., the first period T1 and a second period T2, and is driven by time division.

FIG. 3B illustrates a case where images (hereinafter, right and left images) synthesized in an order of right-eye images and left-eye images are displayed to a user for the second period T2.

Each of the periods T1 and T2 may be divided into data writing periods W1 and W2 and data sustain periods H1 and H2. New images are displayed during the writing period. When the writing of the new images is completed on the entire screen, the screen is maintained for the sustain period.

In the first period T1, an odd pixel OP of the display unit 100 is a left-eye pixel and an even pixel EP is a right-eye pixel. At this time, an odd pixel BOP of the barrier unit 500 is a non-transmitting region and an even pixel BEP is a transmitting pixel.

As shown in FIG. 3A, a path through which the left-eye image is projected to a left eye and the right-eye image is projected to a right eye is formed. The left-eye image projected from the odd pixel OP is formed of images having a predetermined disparity with regard to the right-eye image and the right-eye image projected from the even pixel EP is formed of images having a predetermined disparity with regard to the left-eye image. Therefore, when a user recognizes the left-eye image projected from the odd pixel OP and the right-eye image projected from the even pixel EP through the user's left eye and right eye, respectively, he/she perceives the stereoscopic effect by obtaining depth information like viewing an actual stereoscopic object through a left eye and a right eye.

Next, in FIG. 3B, the odd pixel OP of the display unit 100 is the even-eye image and the even pixel EP is the left-eye pixel. At this time, the odd pixel BOP of the barrier unit 500 is a transmitting region and the even pixel BEP is a non-transmitting region. At this time, as shown in FIG. 3B, a path through which the left-eye image is projected to a left eye and the right-eye image is projected to a right eye is formed.

The left-eye image projected from the odd pixel OP is formed of the images having a predetermined disparity with regard to the left-eye image and the left-eye image projected from the even pixel EP is formed of images having a predetermined disparity with regard to the left-eye image. Therefore, when a user recognizes the right-eye image projected from the odd pixel OP and the left-eye image projected from the even pixel EP through the user's left eye and right eye, respectively, he/she perceives the stereoscopic effect by obtaining depth information like viewing an actual stereoscopic object through a left eye and a right eye.

As such, in the first period T1, the odd pixel is displayed to a left eye and the even pixel is displayed to a right eye, and, in the second period T2, the odd pixel is displayed to a right eye and the even pixel is displayed to a left eye. Therefore, the user can view the stereoscopic image having the same resolution as the plane image. However, since images are displayed along the scan direction where the scan signals are transferred to the plurality of scan lines S1 to Sn, a region where the left and right images and the right and left images overlap occurs.

At this time, when the right and left images are displayed in the entire image, when the left and right images starts to display at the writing period of the first period T1, the barrier is a suitable pattern for the right and left images, but image quality is deteriorated due to the input of the left and right images. Likewise, when the right and left images start to display during the writing period W2 of the second period T2, the barrier is a suitable pattern for the right and left images, but the image quality is deteriorated due to the input of the left and right images.

Embodiments drive the display unit 100 by dividing the display unit 100 into two regions 102 and 104 to prevent the left and right images and the right and left images from overlapping during the first and second writing periods W1 and W2, as described in detail with reference to FIGS. 5A to 5D below.

Referring back to FIGS. 1 and 4, the barrier driver 600 may generate the first and second barrier driving signals CB1 and CB2 that operate the barrier unit 500 according to the barrier control signal CONT3 and may transfer them to the barrier unit 500. The first and second barrier driving signals CB1 and CB2 may be respectively transferred to a first sub-barrier 502 and a second sub-barrier 504. The first and second sub-barriers 502, 504 may respectively correspond to columns of odd and even pixels.

If the first barrier driving signal CB1 equals or exceeds a predetermined threshold voltage, the first sub-barrier 502 may become non-transmitting. If the second barrier driving signal CB2 equals or exceeds a predetermined threshold voltage or more, the second sub-barrier 504 may become non-transmitting.

The first and second barrier driving signals CB1 and CB2 according to the exemplary embodiment may alternately equal or exceed the predetermined threshold voltage for one frame. In detail, the voltage may be changed in synchronization with a point in time where the scan signal is input to the scan line Si of the display unit 100. A detailed description thereof will be given below with reference to FIGS. 5A to 5D.

The voltage supplying unit 700 may supply the first and second driving voltages ELV1 and ELV2 to the first and second regions 102 and 104 of the display unit 100, respectively, according to the voltage supplying control signal CONT4.

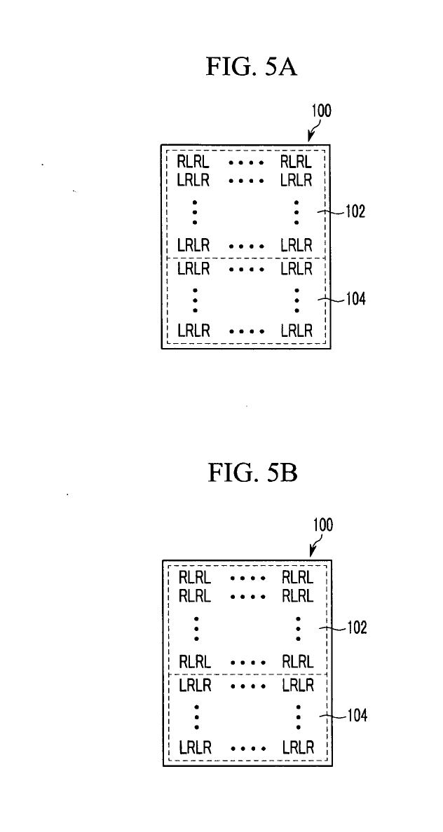

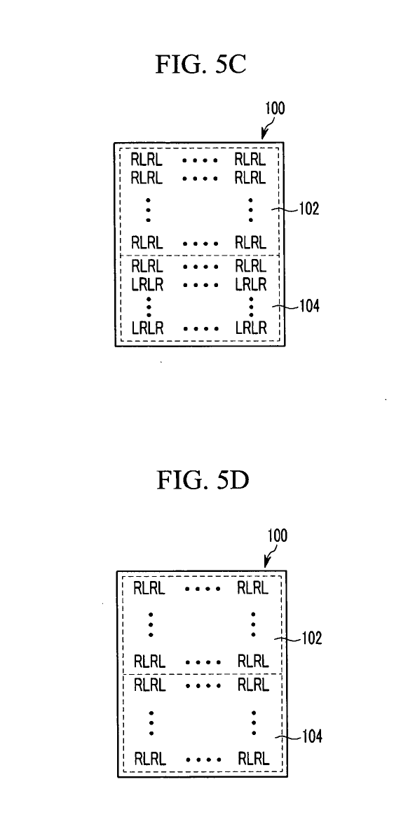

A driving method of the electronic imaging device according to the first exemplary embodiment having the above configuration will be described as follows. FIGS. 5A to 5D illustrate the display unit 100 while the electron imaging device changes from the left and right images LR to the right and left images RL. FIG. 6 illustrates the first and second driving voltages ELV1 and ELV2. FIG. 7 illustrates the first and second barrier driving signals CB1 and CB2.

Referring to FIG. 5A, when the right and left images RL start to be written in the first region 102 while the left and right images LR are displayed on the entire display unit 100, the voltage supplying unit 700 may supply the first driving voltage ELV1 having the turn-off voltage VOFF level to the first region 102. At this time, the driving transistor M1 of the pixel 110 located in the first region 102 is turned off.

The second driving voltage ELV2 may have the turn on voltage VON level and the first barrier driving signal CB1 may maintain a level equal to or greater than the predetermined threshold voltage. Further, the second barrier driving signal CB2 may maintain a level less than the predetermined threshold voltage. Therefore, when the first sub-barrier 502 becomes non-transmitting, i.e., suitable for the left and right image LR, the first region 102 is in the turned off state even if the right and left image RL is written. Thus, overlap of the right and left image RL and the left and right image LR may be prevented.

Next, referring to FIG. 5B, the voltage supplying unit 700 may supply the first driving voltage ELV1 having the turn-on voltage VON level to the first region 102 at a point in time T3 where the right and left image RL is written throughout the first region 102. At this time, the voltage supplying unit 700 may supply the second driving voltage ELV2 of the turn-off voltage VOFF level to the second region 104 and the barrier driver 600 may drop the first barrier driving signal CB1 to less than the predetermined threshold voltage and may increase the second barrier driving signal CB2 to equal or exceed the predetermined threshold voltage.

In this case, the driving transistor M1 of pixels 110 located in the first region 102 is turned on and the driving transistor M1 of pixels 110 located in the second region 104 is turned off. Further, the first sub-barrier 502 becomes transmitting and the second sub-barrier 504 becomes non-transmitting. That is, the barrier 500 becomes a pattern suitable for the right and left image RL, such that the right and left image RL is displayed in the first region 102. At this time, the second region 104 enters the turn-off state, such that the left and right image LR is not displayed.

Next, referring to FIG. 5C, the right and left image RL starts to write in the second region 104. At this time, the first driving voltage ELV1 may maintain the turn-on voltage VON level and the second driving voltage ELV2 may maintain the turn-off voltage VOFF level. The first barrier driving signal CB1 may maintain the level of less than the predetermined threshold voltage and the second barrier driving signal CB2 may maintain the level of equal to or greater than the predetermined threshold voltage.

Next, referring to FIG. 5D, the voltage supplying unit 700 may supply the second driving voltage ELV2 of the turn-on voltage VON level to the second region 104 at a point in time where the right and left image RL is written throughout the second region 104. At this time, the right and left image RL is displayed throughout the first and second regions 102 and 104.

In other words, the first exemplary embodiment divides the display unit 100 into the first and second regions 102 and 104 to turn-on/off the pixels themselves, thereby preventing the left and right image LR and the right and left image RL of the stereoscopic image from overlapping without dividing the barrier 500.

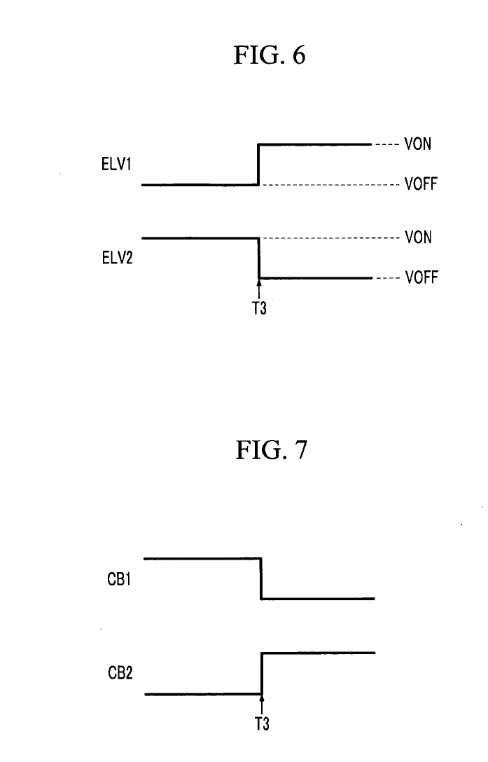

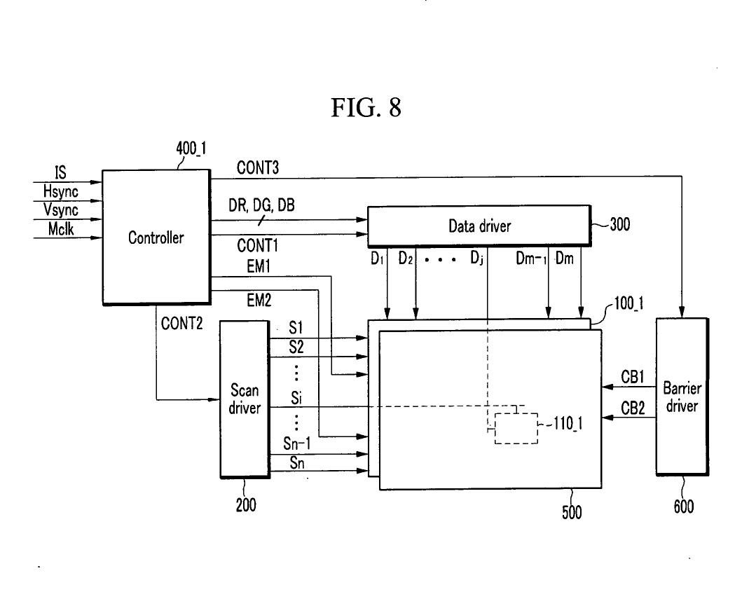

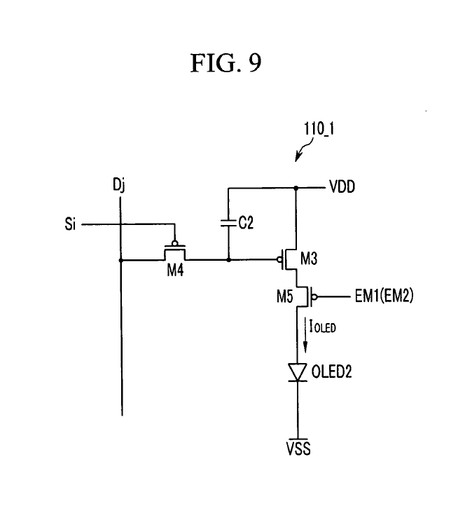

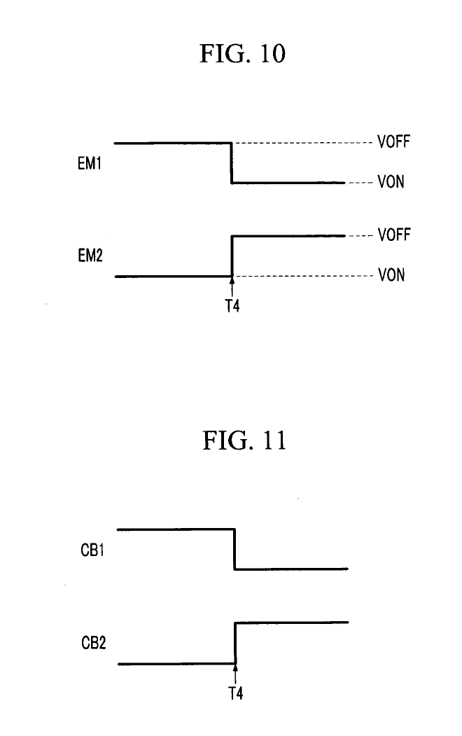

FIG. 8 illustrates a block diagram of an electronic imaging device according to a second exemplary embodiment, wherein the same components as those shown in FIG. 1 are denoted by the same reference numerals and a detailed description thereof will not be repeated. FIG. 9 illustrates an equivalent circuit diagram of the pixel 110_1 shown in FIG. 8. FIG. 10 illustrates the first and second light emission control signals EM1 and EM2. FIG. 11 illustrates the first and second barrier driving signals CB1 and CB2.

Referring to FIG. 8, an electronic imaging device according to the second exemplary embodiment may include a display unit 100_1, the scan driver 200, the data driver 300, a controller 400_1, the barrier unit 500, and the barrier driver 600. The operations of the scan driver 200, the data driver 300, the barrier unit 500, and the barrier driver 600 are the same as in the description of FIG. 1, and therefore the description thereof will not be repeated.

The display unit 100_1 may include the plurality of signal lines S1 to Sn and D1 to Dm, a plurality of voltage lines (not shown), and a plurality of pixels 110_1 that are connected thereto and substantially arranged in a matrix form, when viewed from an equivalent circuit perspective.

Referring to FIG. 9, each pixel 110_1 may include an organic light emitting device OLED2, a driving transistor M3, a capacitor C2, a switching transistor M4, and a light emission control transistor M5.

The organic light emitting device OLED2 may be an organic light emitting diode (OLED), having an anode connected to an output terminal of the light emission control transistor M5 and a cathode connected to a common voltage Vss.

The driving transistor M3 may include a control terminal, an input terminal, and an output terminal. The control terminal may be connected to the switching transistor M4, the input terminal may be connected to an output of the power supply voltage VDD, and the output terminal may be connected to the organic light emitting device OLED2. The capacitor C2 may be connected between the control terminal and the input terminal of the driving transistor M3.

The switching transistor M4 may include a control terminal, an input terminal, and an output terminal. The control terminal may be connected to the scan line Si, the input terminal may be connected to the data line Dj, and the output terminal may be connected to the driving transistor M3.

The light emission control transistor M5 may include a control terminal, an input terminal, and an output terminal. The control terminal may be connected to an end for applying the first light emission control signal EM1 (or, the second light emission control signal EM2), the input terminal may be connected to the driving transistor M3, and the output terminal may be connected to the organic light emitting device OLED2.

If the light emitting control transistor M5 is turned on by the first light emission control signal EM1 (or the second light emission control signal EM2), the light emitting control transistor M5 supplies the current I_{OLED} flowing in the driving transistor M3 to the organic light emitting device OLED2.

In the specific example of FIG. 9, the switching transistor M4, the driving transistor M3, and the light emission control transistor M5 are p-channel FETs. In this case, the control terminal, the input terminal, and the output terminal respectively correspond to a gate, a source, and a drain. However, any one or all of the switching transistor M4, the driving transistor M3, and the light emission control transistor M5 may be another type of transistor, e.g., an n-channel FET. Further, a connection relationship of the driving transistor M3, the switching transistor M4, the capacitor C2, and the light emission control transistor OLED2 may be changed.

Referring back to FIG. 8, the controller 400_1 may receive the input signal IS, the horizontal synchronization signal Hsync, the vertical synchronization signal Vsync, and the main clock signal MCLK from the outside, may generate the scan control signal CONT1, the data control signal CONT2, image data signals DR, DG, and DB, a barrier driver control signal CONT3, and first and second light emission control signals EM1 and EM2, and may transfer them to the scan driver 200, the data driver 300, the barrier driver 500, and the display unit 100_1, respectively.

Herein, the first and second light emission control signals EM1 and EM2 according to the second exemplary embodiment may be signals that control the light emission of the pixel 110_1 located in the first and second regions 102 and 104 (see FIGS. 5A to 5D).

Herein, the first and second light emission control signals EM1 and EM2 each has a turn-on voltage VON that turns on the pixel 110_1 and a turn-off voltage VOFF that turns off the pixel 110_1. In this particular configuration, the turn-on voltage VON is a low voltage level and the off-voltage VOFF is a high voltage level.

In other words, the first exemplary embodiment describes the turn-on/off of the first and second regions 102 and 104, by way of example, using the first and second driving voltages EV1 and EV2, but the second exemplary embodiment describes the turn on/off of the first and second regions 102 and 104, by way of example, using the first and second light emission control signals EM1 and EM2. This will be described below with reference to FIGS. 10 and 11.

Referring to FIG. 10, the first light emission control signal EM1 maintains the turn-off voltage VOFF until the right and left images RL are written throughout the first region 102 (see FIGS. 5A and 5B). At this time, the second light emission control signal EM2 becomes the turn-on voltage VON level. Therefore, the light emission control transistor M5 of pixels 110_1 located in the first region 102 is turned off, such that the first region 102 becomes the turned-off region. The first light emission control signal EM1 becomes the turn-on VON level at a point in time T4 where the right and left image RL is written throughout the first region 102. At this time, the second light emission control signal EM2 becomes the turn-off voltage VOFF level.

Therefore, the first region 102 is turned off until the right and left image RL is written throughout the first region 102. Likewise, the second region 104 is turned off until the right and left image RL is written throughout the second region.

At this time, the first barrier driving signal CB1 maintains a voltage equal to or greater than the threshold voltage before time T4 and then drops to the below the threshold voltage at the point in time T4, as shown in FIG. 11. The second barrier driving signal CB2 maintains a voltage less than the threshold voltage before time T4 and rises to equal or exceed the threshold voltage or more at time T4.

Therefore, the second exemplary embodiment has only the light emission control transistor M5 separately and has the same effect as the first exemplary embodiment.

As described above, the electronic imaging device and the driving method thereof according to the present invention does not divide the barrier but turns-on/off pixels of the display unit itself, making it possible to reduce power consumption.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the appended claims.

What is claimed is:

1. An electronic imaging device, comprising:
a display unit including a plurality of pixels divided into a first region and a second region; and
a controller that generates first and second control signals to control the light emission of the plurality of pixels and applies the first and second control signals to the plurality of pixels in the first region and the plurality of pixels in the second region, respectively,
wherein the controller generates and applies the first control signal as a turn-off signal when second stereoscopic images synthesized in a second order different from a first order are displayed in the first region after first stereoscopic images synthesized in the first order are displayed in both the first and second regions.

2. The electronic imaging device as claimed in claim 1, wherein
the controller generates and supplies the second control signal as a turn-off signal and generates and supplies the first control signal as a turn-on signal when the second stereoscopic images are displayed in the second region after the second stereoscopic images are displayed throughout the first region.

3. The electronic imaging device as claimed in claim 2, further comprising a barrier unit including a first sub-barrier that displays the first stereoscopic images and a second sub-barrier that displays the second stereoscopic images.

4. The electronic imaging device as claimed in claim 3, wherein:
when the first stereoscopic images are displayed on the first and second regions, the first sub-barrier becomes non-transmitting and the second sub-barrier becomes transmitting; and
when the second stereoscopic images are displayed in the first and second regions, the second sub-barrier becomes non-transmitting and the first sub-barrier becomes transmitting.

5. The electronic imaging device as claimed in claim 2, wherein each of the plurality of pixels includes:
a driving transistor including a first terminal and a second terminal, the first terminal configured to receive any one of the first and second control signals, the second terminal configured to receive data signals, the driving transistor configured to output a difference signal corresponding to a difference between a signal level at the first terminal and the second terminal; and
an organic light emitting device connected to the driving transistor and configured to emit light in accordance with the difference signal.

6. The electronic imaging device as claimed in claim 1, wherein the first order is an order of left-eye images and right-eye images and the second order is an order of right-eye images and left-eye images.

7. The electronic imaging device as claimed in claim 1, wherein the first and second control signals are drive voltages.

8. The electronic imaging device as claimed in claim 1, wherein the first and second control signals are light emission control signals.

9. The electronic imaging device as claimed in claim 8, wherein the controller generates and applies the second light emission control signal as a turn-off voltage at a point in time when the second stereoscopic images are displayed in the second region after the second stereoscopic images are displayed throughout the first region.

10. The electronic imaging device as claimed in claim 9, wherein each of the plurality of pixels includes:
a switching device that is turned on by the scan signal and transfers the data signals;
a driving transistor that is driven according to the output of the switching device and generates a current;
an organic light emitting device that is light-emitted by the current; and
a light emission control switch connected between the driving transistor and the organic light emitting device and is turned on by any one of the first and second light emission control signals to supply the current to the organic light emitting device.

11. A method of driving an electronic imaging device including a display unit having a plurality of pixels including a plurality of driving transistors supplying a plurality currents to a plurality of organic light emitting devices, the method comprising:
displaying first stereoscopic images synthesized in a first order throughout a first region where a plurality of first pixels of the plurality of pixels of the display unit are located and a second region where another plurality of second pixels of the plurality of pixels of the display unit are located; and
turning off the plurality of first pixels when the second stereoscopic images synthesized in a second order different from the first order starts to display in the first region.

12. The method of driving an electronic imaging device as claimed in claim 11, wherein turning off the plurality of first pixels includes using a driving voltage applied to the driving transistor as a turn-off voltage.

13. The method of driving an electronic imaging device as claimed in claim 11, further comprising:
turning off the plurality of second pixels when the second stereoscopic images are displayed in the second region; and
turning on the plurality of first pixels when the second stereoscopic images are displayed throughout the first region.

14. The method of driving an electronic imaging device as claimed in claim 13, further comprising:
making the first sub-barrier non-transmitting and the second sub-barrier transmitting, for a period where the first stereoscopic images are displayed on the entire display unit and where the second stereoscopic images are displayed throughout the first region; and
making the second sub-barrier non-transmitting and the first sub-barrier transmitting, from a point in time when the second stereoscopic images are displayed in the second region.

15. The method of driving an electronic imaging device as claimed in claim 13, wherein the first order is an order of left-eye images and right-eye images and the second order is an order of right-eye images and left-eye images.

16. The method of driving an electronic imaging device as claimed in claim 11, wherein turning off the plurality of first pixels includes turning off light emission control switches associated with corresponding first pixels.

17. The method of driving an electronic imaging device as claimed in claim 16, further comprising turning on the light emission control switches associated with the plurality of first pixels when second stereoscopic images start to display in the second region.

18. The method of driving an electronic imaging device as claimed in claim 11, wherein displaying includes emitting light from an organic light emitting device.

19. The method of driving an electronic imaging device as claimed in claim 18, wherein emitting light includes supplying current from a driving transistor to the organic light emitting device.

20. The method of driving an electronic imaging device as claimed in claim 19, wherein supplying the current include turning on a light emission control switch connected between the driving transistor and the organic light emitting device.
